(19) United States
(12) Patent Application Publication
(10) Pub. No.: US 2017/0045930 A1
(43) Pub. Date: Feb. 16, 2017

(54) DOWNHOLE TOOL WITH PLURAL DATA STORES

(71) Applicant: Evolution Engineering Inc., Calgary (CA)

(72) Inventors: Robin Cody ROBSON, Calgary (CA); Aaron William LOGAN, Calgary (CA); Barry Daniel BUTERNOWSKY, Calgary (CA); Kurtis Kenneth Lee WEST, Calgary (CA)

(21) Appl. No.: 15/236,288

(22) Filed: Aug. 12, 2016

Related U.S. Application Data
(60) Provisional application No. 62/205,592, filed on Aug. 14, 2015.

(51) Int. Cl. G06F 1/32; G06F 12/02

(52) U.S. Cl. CPC G06F 1/3287; G06F 12/0246; G06F 2212/7201

(57) ABSTRACT

A data logger comprising a first data store, a second data store and a controller connected to receive output from a temperature sensor indicating a temperature of the first data store. The controller may be configured to write data to the first data store and to switch to writing the data on the second data store if the indicated temperature of the first data store exceeds a first threshold temperature. The first and second data stores may be of different types. Upon the temperature of the first data store transitioning from above the first threshold to below the first threshold, the controller may be configured to copy any data recorded in the second data store to the first data store.

### TECHNICAL FIELD

This application relates to subsurface drilling, specifically, to downhole tools which include data logging functions. Embodiments are applicable to drilling wells for recovering hydrocarbons.

### BACKGROUND

Recovering hydrocarbons from subterranean zones typically involves drilling wellbores.

Wellbores are made using surface-located drilling equipment which drives a drill string that eventually extends from the surface equipment to the formation or subterranean zone of interest. The drill string can extend thousands of feet or meters below the surface. The terminal end of the drill string includes a drill bit for drilling (or extending) the wellbore. Drilling fluid, usually in the form of a drilling “mud”, is typically pumped through the drill string. The drilling fluid cools and lubricates the drill bit and also carries cuttings back to the surface. Drilling fluid may also be used to help control bottom hole pressure to inhibit hydrocarbon influx from the formation into the wellbore and potential blow out at surface.

Bottom hole assembly (BHA) is the name given to the equipment at the terminal end of a drill string. In addition to a drill bit, a BHA may comprise elements such as: apparatus for steering the direction of the drilling (e.g. a steerable downhole mud motor or rotary steerable system); sensors for measuring properties of the surrounding geological formations (e.g. sensors for use in well logging); sensors for measuring downhole conditions as drilling progresses; one or more systems for telemetry of data to the surface; stabilizers; heavy weight drill collars; pulsers; and the like. The BHA is typically advanced into the wellbore by a string of metallic tubulars (drill pipe).

Modern drilling systems may include any of a wide range of mechanical/electronic systems in the BHA or at other downhole locations. Such electronics systems may be packaged as part of a downhole probe. A downhole probe may comprise any active mechanical, electronic, and/or electromechanical system that operates downhole. A probe may provide any of a wide range of functions including, without limitation: data acquisition; measuring properties of the surrounding geological formations (e.g. well logging); measuring downhole conditions as drilling progresses; controlling downhole equipment; monitoring status of downhole equipment; directional drilling applications; measuring while drilling (MWD) applications; logging while drilling (LWD) applications; measuring properties of downhole fluids; and the like. A probe may comprise one or more systems for: telemetry of data to the surface; collecting data by way of sensors (e.g. sensors for use in well logging) that may include one or more of vibration sensors, magnetometers, inclinometers, accelerometers, nuclear particle detectors, electromagnetic detectors, acoustic detectors, and others; acquiring images; measuring fluid flow; determining directions; emitting signals, particles or fields for detection by other devices; interfacing to other downhole equipment; sampling downhole fluids; etc.

Downhole conditions can be harsh. A probe may experience high temperatures; vibrations (including axial, lateral, and torsional vibrations); shocks; immersion in drilling fluids; high pressures (20,000 p.s.i. or more in some cases); turbulence and pulsations in the flow of drilling fluid past the probe; fluid initiated harmonics; and torsional acceleration events from slip which can lead to side-to-side and/or torsional movement of the probe. These conditions can shorten the lifespan of downhole probes and can increase the probability that a downhole probe will fail in use. Replacing a downhole probe that fails while drilling can involve very great expense.

There remains a need for ways to provide downhole tools that are cost-effective.

### SUMMARY

The invention has a number of different aspects. These aspects include, without limitation, kits, methods, systems and apparatus for data logging. Particular kits, methods, systems and apparatus for data logging according to the invention may be applied in high temperature environments (e.g. over 100° C.) such as may be encountered in downhole drilling.

One example aspect provides a data logger comprising a first data store, a second data store and a controller connected to receive output from a temperature sensor indicating a temperature of the first data store. The controller may be configured to write data to the first data store and to switch to writing the data on the second data store if the indicated temperature of the first data store exceeds a first threshold temperature. The first and second data stores may be of different types. The second data store may have an operating temperature range that extends to temperatures above a maximum operating temperature of the first data store. The first threshold temperature may be within or at a limit of an operating temperature range for the first data store.

In some embodiments, the data logger comprises a power supply connected to supply a bias voltage to the first data store and the controller is connected to discontinue supply of the bias voltage to the first data store if the indicated temperature of the first data store exceeds a second threshold. The second threshold may be equal to or greater than the first threshold.

In some embodiments, upon the temperature of the first data store transitioning from above the first threshold to below the first threshold, the controller is configured to copy any data recorded in the second data store to the first data store.

In some embodiments, the first data store comprises a non-volatile memory. In other embodiments, the first data store comprises a flash RAM. In further embodiments, each of the first and second data stores comprises a single integrated circuit. In some embodiments, the maximum operating temperature of the first data store is 80° C. or less. In some embodiments, the capacity of the first data store is at least twice a capacity of the second data store.

In some embodiments, the data logger comprises a network interface connectable to receive data to be logged. The network interface may comprise a CANBUS interface.

Further aspects of the invention and features of example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a schematic view of a drilling operation.

FIG. 2 is a block diagram showing functional components of an example downhole tool.

FIG. 3 is a block diagram showing another downhole tool according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

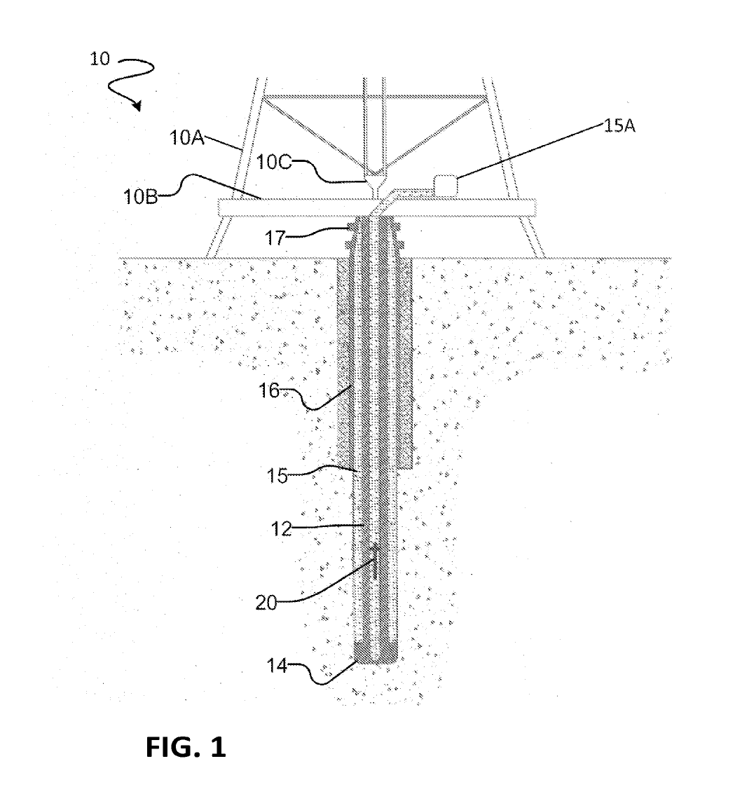

FIG. 1 shows schematically an example drilling operation. A drill rig 10 drives a drill string 12 which includes sections of drill pipe that extend to a drill bit 14. The illustrated drill rig 10 includes a derrick 10A, a rig floor 10B and draw works 10C for supporting the drill string. Drill bit 14 is larger in diameter than the drill string above the drill bit. An annular region 15 surrounding the drill string is typically filled with drilling fluid. The drilling fluid is pumped through a bore in the drill string to the drill bit and returns to the surface through annular region 15 carrying cuttings from the drilling operation. As the well is drilled, a casing 16 may be made in the well bore. A blow out preventer 17 is supported at a top end of the casing. The drill rig illustrated in FIG. 1 is an example only. The methods and apparatus described herein are not specific to any particular type of drill rig.

This invention provides downhole tools which have two or more data stores having different properties. Some embodiments address the problem that electronic components, including memories that are useful for storing data, can typically only operate reliably within a given temperature range. Manufacturers of memory devices typically specify a range of acceptable operating temperatures for their memory devices. A problem with downhole applications is that temperatures are often quite high. In some cases, temperatures are well over 100° C. For example, temperatures of 150° C. are sometimes encountered in downhole environments. Such temperatures are in excess of the maximum specified operating temperatures for many memory devices. For example, many memory devices have maximum operating temperatures of 65° C.

This issue is currently addressed by using in downhole tools memory devices that have high temperature ratings. Memory devices having maximum operating temperatures of 200° C. or more are commercially available. However, such memory devices tend to be very expensive and tend to require more space than low temperature rated data storage devices. Furthermore, individual high-temperature memory devices have data storage capacities that are significantly less than are available in individual devices having lower temperature ratings.

An alternative to using high temperature rated storage devices is to use the commonly available and relatively inexpensive storage devices designed for operation at low temperatures and to use these storage devices notwithstanding the fact that the downhole temperatures may exceed the maximum operating temperature ratings of the low temperature devices. This, however, results in a severely reduced lifetime for these devices. If a memory device fails while the downhole tool is in use then it may become necessary to trip the downhole tool out of the well bore in order to replace the failed memory device. This can be very expensive.

This invention takes advantage of the fact that commonly available low temperature rated data storage devices such as flash integrated circuits are typically rated to survive at the temperatures commonly experienced downhole as long as they are not powered, operated (e.g. read/write) above their maximum operating temperatures. For example, the Spansion™ NAND flash memory chip is available in 1 Gb, 2 Gb, 4 Gb densities and has an operating temperature range of −40° C. to 85° C., a temperature range under bias of −50° C. to 125° C., and a storage temperature range of −65° C. to 150° C.

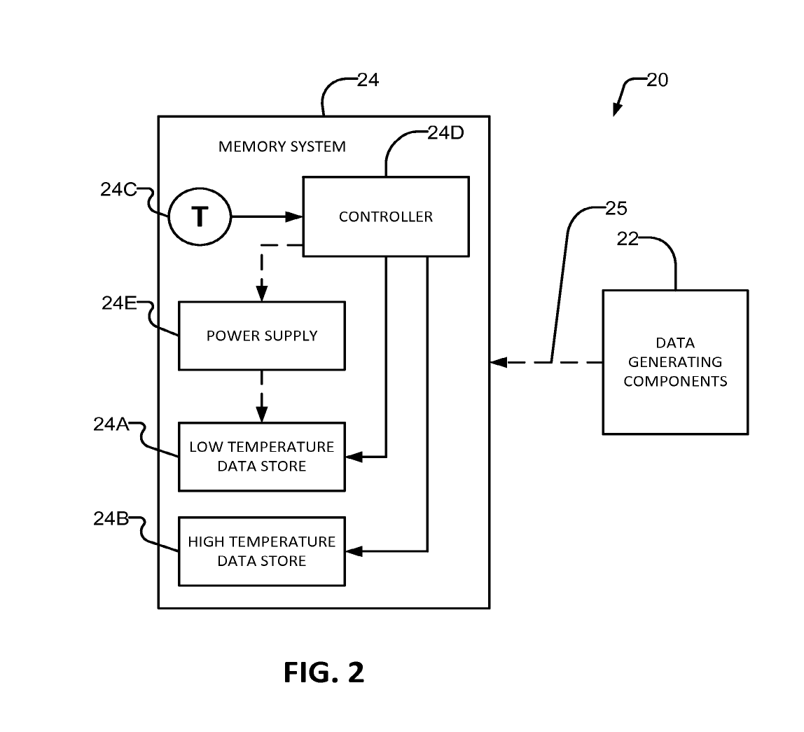

FIG. 2 is a block diagram showing relevant parts of a downhole tool according to an example embodiment of the invention. Downhole tool 20 comprises data generating components 22. Data generating components 22 may, for example, comprise any number of sensors such as gamma sensors, magnetic field sensors, resistivity sensors, optical sensors, and the like. Data generating components 22 are connected to a memory system 24 by one or more data buses 25.

Memory system 24 includes two data storage devices that differ from one another in their operating temperature ranges. Device 24A may be a standard data storage device, such as a flash IC which has an operating temperature range, for example, having a maximum operating temperature of 85° C. or 125° C. or less. In some embodiments, data storage device 24A has a maximum operating temperature of 65° C. or 75° C., for example.

A second data storage device 24B has a higher operating temperature range. For example, the operating temperature range of data storage device 24B may be up to 175° C. or 200° C. As a consequence, data storage device 24A may be significantly less expensive than data storage device 24B. In some embodiments, data storage device 24A has a significantly larger capacity for data than data storage device 24B. For example, data storage device 24A may comprise a flash storage drive having a capacity between 64 megabits and 1 gigabit while data storage device 24B may comprise a flash storage drive having a capacity between 8 megabits and 64 megabits.

To improve performance, storage devices 24A, 24B may have read/write speeds that are approximately the same. In other embodiments, the writing speed is slower than the reading speed.

Memory system 24 includes a temperature sensor 24C and a controller 24D which receives an input from the temperature sensor 24C. Controller 24D controls whether data received by way of data buses 25 is written to data storage device 24A or data storage device 24B. If the temperature detected by sensor 24C is greater than a threshold temperature (indicating that the maximum operating temperature of data storage device 24A has been reached or has nearly been reached) then data storage controller 24D directs data received on bus or busses 25 to high temperature data store 24B. On the other hand, if temperature sensor 24D detects a temperature lower than the threshold, then received data is stored on low-temperature device 24B.

In some embodiments, if the ambient temperature is above the threshold temperature for a period of time, and data has been buffered into higher temperature data store 24B, and the temperature then falls to below the threshold temperature, upon the temperature falling to below the threshold temperature (and perhaps remaining below the threshold temperature for a period of time), any data that has been recorded to high temperature data store 24B may be transferred on to low temperature data store 24B. By doing so, capacity of the high-temperature data store 24B may be freed in case the temperature again rises to a temperature above the threshold temperature.

In some embodiments, data is stored in data store 24A using a table. The table may organize data entries into sectors. As data is entered in data store 24A, either from data store 24B or from elsewhere, it would increase the sector number counter and save the new data accordingly. In other embodiments, a pointer is included with data entries to indicate where the data is written or should be written.

In some embodiments, controller 24D controls a power supply 24E that supplies bias voltage to low-temperature data store 24A. In such embodiments, where the temperature detected by temperature sensor 24C exceeds a threshold (that can be the same or higher than the first threshold mentioned above), then controller 24D may control supply 24E to discontinue supplying bias power to data storage device 24A. This may extend the temperature range to which data storage device 24A may be exposed without damage.

In an example embodiment, a controller 24D discontinues writing to low temperature memory 24A and writes instead to a higher temperature memory 24B when a temperature as sensed by sensor 24C exceeds approximately 65° C. If the temperature rises to a temperature of, for example, above 80° C., bias voltage to low temperature data store 24A is shut off. If the temperature falls again to a temperature within the operating range of low temperature data store 24A, then controller 24D once again applies bias voltage to data storage device 24A and transfers in to data storage device 24A any data that has accumulated in high temperature data storage device 24B. Controller 24D then directs any further data received to low-temperature data storage device 24A until such time as the temperature once again rises to above the first threshold. In some embodiments, data storage device 24A comprises one or more flash RAM devices. Data storage device 24B may also comprise one or more flash RAM devices.

Temperature sensor 24C is not necessarily dedicated to memory system 24. For example, temperature sensor 24C may be a temperature sensor that senses a temperature of downhole tool 20 generally.

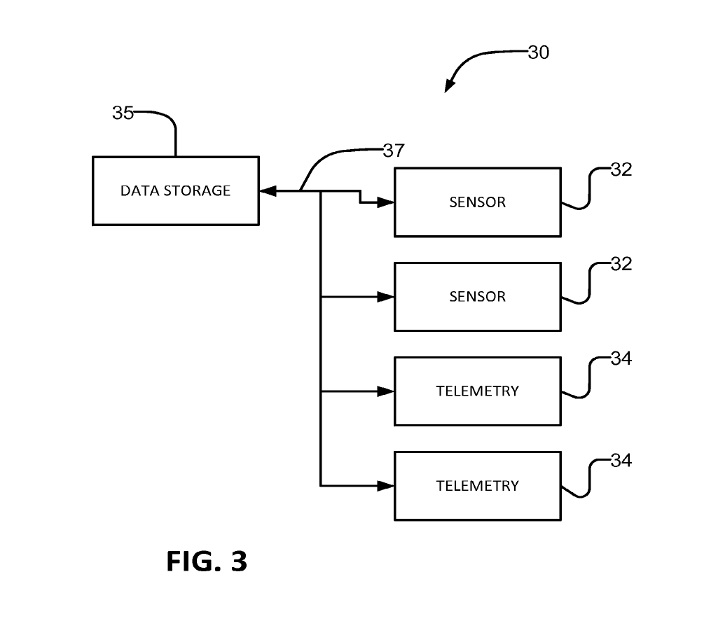

FIG. 3 shows an example downhole tool 30 according to one embodiment. Downhole tool 30 comprises one or more sensor modules 32, one or more data telemetry modules 34, and a data storage module 35 all interconnected by a bus 37. Bus 37 may, for example, comprise a CANBUS, an RS-422, an RS-485 or a K-Line. Data storage module 35 may have a construction as shown for data store 24 of FIG. 2, for example.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a,” “an,” and “the” also include the meaning of any appropriate plural forms.

Words that indicate directions such as “vertical,” “transverse,” “horizontal,” “upward,” “downward,” “forward,” “backward,” “inward,” “outward,” “vertical,” “transverse,” “left,” “right,” “front,” “back,” “top,” “bottom,” “below,” “above,” “under,” and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, drill string component, drill rig system, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A data logger comprising:
a first data store;
a second data store;
a controller connected to receive an output from a temperature sensor indicating a temperature of the first data store, the controller configured to write data to the first data store and to switch to writing the data to the second data store if the indicated temperature of the first data store exceeds a first threshold temperature.

2. A data logger according to claim 1 comprising a power supply connected to supply a bias voltage to the first data store wherein the controller is connected to discontinue supply of the bias voltage to the first data store if the indicated temperature of the first data store exceeds a second threshold that is equal to or greater than the first threshold.

3. A data logger according to claim 1 wherein, upon the temperature of the first data store transitioning from above the first threshold to below the first threshold, the controller is configured to copy any data recorded in the second data store to the first data store.

4. A data logger according to claim 1 wherein the first data store comprises a non-volatile memory.

5. A data logger according to claim 4 wherein the first data store comprises a flash RAM.

6. A data logger according to claim 1 wherein the first threshold temperature is 125° C. or less.

7. A data logger according to claim 1 wherein a maximum operating temperature of the second data store is 150° C. or more.

8. A data logger according to claim 1 comprising a network interface connectable to receive data to be logged.

9. A data logger according to claim 8 wherein the network interface comprises one of: a CANBUS, an RS-485, an RS-422 and a K-line interface.

10. A data logger according to claim 1 wherein a capacity of the first data store is at least twice a capacity of the second data store.

11. A data logger according to claim 1 wherein each of the first and second data stores comprises a single integrated circuit.

12. A data logger according to claim 1 wherein a maximum operating temperature of the first data store is 80° C. or less.

13. A data logger according to claim 1 wherein the data logger is included in a downhole tool comprising one or more sensors and the data comprises outputs from the one or more sensors.

14. A data logger according to claim 13 wherein the sensors include one or more of a gamma sensor, a magnetic field sensor, a resistivity sensor, and an optical sensor.

15. A data logger according to claim 1 wherein the data logger comprises a data bus and the data is received on the data bus.

16. A data logger according to claim 1 wherein the controller is configured to write any data that has been recorded to the second data store to the first data store in response to detecting that the output of the temperature sensor has dropped from above the first threshold temperature to a temperature below the first threshold temperature.

17. A downhole tool comprising one or more sensor modules and a data storage module interconnected by a data bus, the data storage module comprising:
a first data store;
a second data store;
a controller connected to receive an output from a temperature sensor indicating a temperature of the first data store, the controller configured to write data to the first data store and to switch to writing the data to the second data store if the indicated temperature of the first data store exceeds a first threshold temperature.

18. A method for storing data in a downhole tool, the method comprising:
comparing a temperature measured by a temperature sensor to a threshold;
if the temperature is below the threshold writing the data to a first data store;
if the temperature exceeds the threshold writing the data to a second data store.

19. The method according to claim 18 comprising, in response to the temperature being above a second threshold equal to or higher than the threshold, turning off a bias voltage to the first data store.
